(19) United States
(12) Patent Application Publication
(10) Pub. No.: US 2025/0229864 A1
(43) Pub. Date: Jul. 17, 2025

(54) CAMPER TRAILER FOR A BICYCLE AND IMPROVEMENTS THEREIN

(71) Applicant: Philip James Brule, Ottawa (CA)

(72) Inventor: Philip James Brule, Ottawa (CA)

(21) Appl. No.: 18/935,352

(22) Filed: Nov. 1, 2024

(30) Foreign Application Priority Data
Nov. 3, 2023 (CA) 3218739

(51) Int. Cl. B62K 27/00; B62J 43/26; B62J 43/30; B62J 50/22; B62K 27/12; B62M 6/85

(52) U.S. Cl. CPC B62K 27/003; B62K 27/12; B62J 43/26; B62J 43/30; B62J 50/22; B62M 6/85

(57) ABSTRACT

A camper trailer for a bicycle comprising, a housing or camper unit and a base frame having one or more wheels and a trailer connection assembly for coupling the camper trailer to the bicycle for towing the camper trailer. The housing unit is configured to attach to the base frame and comprises a lower section and an upper section. The lower section and the upper section are coupled together on a common side with a hinge connector. The upper section is configured to move between an open or camping position and a closed or storage position. The housing unit includes one or more flexible panels configured to define an interior camper space when the housing unit is in the open position. According to another aspect, the base frame includes one or more brackets or clamps to attach the camper trailer to a car rack for transportation and/or additional storage.

### FIELD OF THE INVENTION

The present invention relates to a camper trailer, and more particularly, to a camper trailer suitable for a bicycle and improvements therein.

### BACKGROUND OF THE INVENTION

In the art, a bicycle can be configured with one or more rear and/or front panniers for camping trips and/or extended rides. Panniers, however, have limited capacity both in terms of size and weight. Overloaded and/or overweighted pannier bags can also affect the handling of the bicycle.

Accordingly, there remains a need for improvements in the art.

### BRIEF SUMMARY OF THE INVENTION

The present invention is directed to a camper trailer suitable for use with a bicycle for extended rides, touring, camping trips and the like.

According to one aspect, the camper trailer is configured to be towed by a bicycle for bicycle touring or camping. The camper trailer is further configured to be mounted on a rack, for example, a roof-top rack, installed on a vehicle. The camper trailer can also function as a roof top cargo carrier to provide additional storage. The vehicle may also be equipped with a bicycle carrier rack for transporting one or more bicycles.

According to an exemplary embodiment, the camper trailer is configured to provide a watertight housing for carrying camping equipment and other bulky gear, such as sleeping bag(s), mattress pad(s) and other bulky items, such insulated clothing, heavier food items. The bicycle panniers are available for packing and carrying wet weather gear, emergency repair equipment, and food etc. According to another aspect, the camper trailer is configured to accommodate one or more individuals for sleeping, for respite from the elements or insects, and the like.

According to one embodiment, the present invention is directed a camper trailer for a bicycle, the camper trailer comprising: a base frame, the base frame comprising one or more wheels and a connection assembly for coupling the camper trailer to the bicycle for towing the camper trailer; a housing unit, the housing unit being configured to attach to the base frame; the housing unit comprising a lower section and an upper section, the lower section and the upper section being coupled together on a common side with a hinge connector, and the upper section being further configured to move between an open or camping position and a closed or storage position; and the housing unit including one or more flexible panels configured to define an interior camper space when the housing unit is moved into the open position.

According to another embodiment, the present invention is directed to a camper trailer for a bicycle, the camper trailer comprises: a base frame, the base frame comprising one or more wheels and a connection assembly for coupling the camper trailer to the bicycle for towing the camper trailer; a housing unit, the housing unit being configured to attach to the base frame; the housing unit comprising a lower section and an upper section, the lower section and the upper section being coupled together on a common side with a hinge connector, and the upper section being further configured to move between an open or camping position and a closed or storage position; the housing unit including one or more flexible panels configured to define an interior camper space when the housing unit is moved into the open position; and wherein the base frame includes one or more attachments for securing the camper trailer to a rack installed on a vehicle; and wherein the one or more wheels includes a motor configured to move the camper trailer under power in response to one or more control signals.

According to another embodiment, the present invention is directed to a camper trailer having a housing unit, and the housing unit is configured to be convertible into a roof rack or roof top carrier. The housing unit includes one or more brackets for coupling the housing unit to a roof rack installed on a vehicle.

Other aspects and features of the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 shows in diagrammatic form a camper trailer for a bicycle according to an embodiment of the present invention in a side view;

FIG. 2 is a top plan view of the camper trailer of FIG. 1 and according to an embodiment of the present invention;

FIG. 3 is a front elevational view of the camper trailer of FIG. 1 and according to an embodiment of the present invention;

FIG. 4 shows in diagrammatic form a trailer connection assembly for the coupling the camper trailer to a bicycle according to an embodiment of the present invention;

FIG. 5A shows in diagrammatic form a trailer connection assembly for the camper trailer according to another embodiment of the present invention;

FIG. 5B shows in diagrammatic form an optional foldable seat configured for mounting on the trailer connection assembly;

FIG. 5C shows in diagrammatic form another view of the optional foldable seat of FIG. 5B;

FIG. 6 shows in diagrammatic form a rear stand assembly for the camper trailer according to an embodiment of the present invention;

FIG. 7 shows in diagrammatic form a bracket for attaching or coupling the camper trailer housing to the camper trailer frame according to an embodiment of the present invention;

FIG. 8 shows in diagrammatic form the camper trailer attached or connected to a roof carrier rack attached to the roof of a vehicle; and

FIG. 9 shows in diagrammatic form a camper trailer for a bicycle according to another embodiment of the present invention in a front elevational view.

Like reference numerals indicate like or corresponding elements or components in the drawings.

### DETAILED DESCRIPTION OF THE EMBODIMENTS

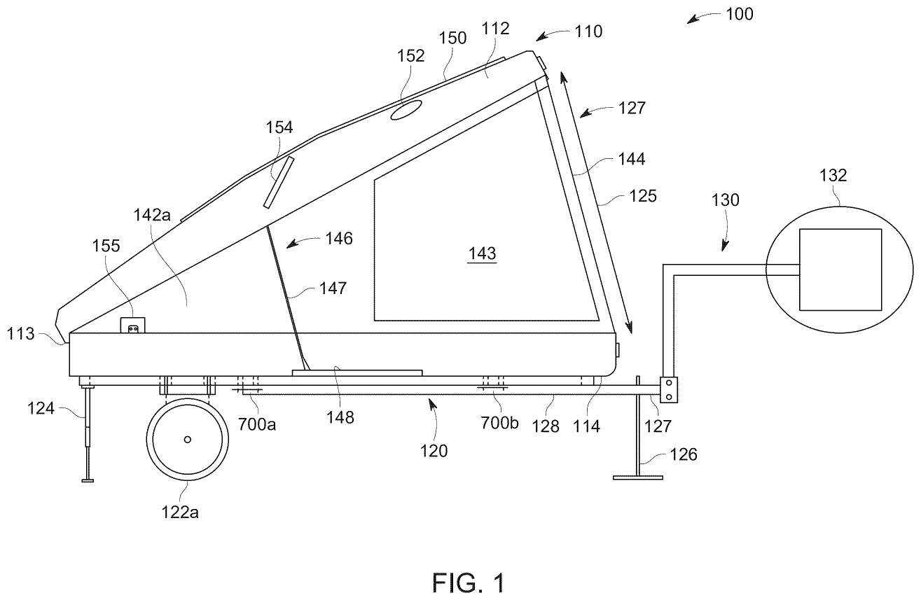

Reference is made to FIG. 1, which shows in diagrammatic form a camper trailer according to an embodiment of the present invention and indicated generally by reference 100. The camper trailer 100 is configured to be used with a bicycle as will be described in more detail below. It will, however, be appreciated that the camper trailer may be used by other types of human powered vehicles and/or motorized vehicles.

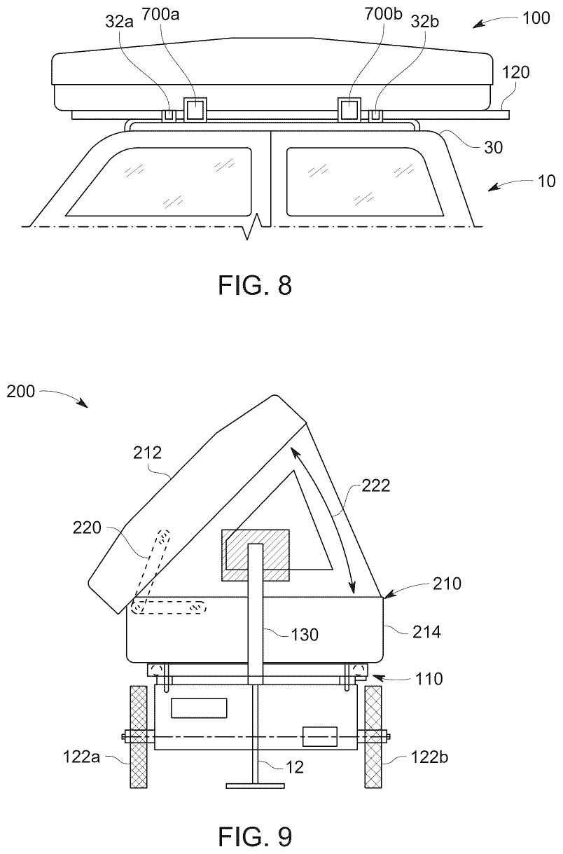

As shown in FIG. 1, the camper trailer 100 comprises a housing or camper unit 110 and a trailer or base frame 120. The housing unit 110 is attached or mounted to the trailer frame 120 as will be described in more detail below with reference to FIG. 7. The housing or camper unit 110 comprises an upper housing section or shell indicated generally by reference 112 and a lower housing section or shell indicated generally by reference 114. The housing sections 112, 114 are connected at one end (e.g. the rear end of the trailer) by a hinge, or other pivotable connection mechanism, indicated generally by reference 113 in FIG. 1. The hinge 113 may be of the form as shown in FIG. 8 and indicated by reference 213.

According to an exemplary embodiment, the upper housing section or shell 112 and the lower housing section or shell 114 are formed or manufactured from a rigid polymer material or other lightweight material that provides a good weight to strength ratio. The upper and lower shells 112, 114 may be formed with exterior contoured or rounded edges to improve aerodynamics (for instance when the camper trailer is mounted on a cargo rack secured to the top of a vehicle). The lower shell 114 may also be formed with interior contours and/or compartments to provide a more comfortable sleeping surface for the occupant(s). The compartments may be configured with storage compartments or pockets.

Referring to FIG. 1, the upper housing section or shell 112 for the camper trailer 100 is configured to swing or pivot between an open or camping or “tent” position or mode and a closed or trailer mode position for travel as indicated by arrow 125 and generally by reference 127. According to an exemplary implementation, the camper trailer 100 is configured with side panels 142, indicated individually by references 142a and 142b, and a front panel 144. In the open position 127, the side panels 142 and front panel 144 form a tent or sleeping enclosure. The side panels 142 and front panel 144 may be made from a weather proofed material such as nylon or other flexible material or fabric. The camper trailer 100 includes a rod or support mechanism 146 comprising a support rod 147 to hold or maintain the camper trailer 100 in the open or tent position 127. According to an exemplary implementation, the rod 147 is configured to slide or move in a sliding track 148 between an open and a closed position.

According to an exemplary embodiment, the side panels 142 are configured with a window (or windows) indicated by reference 143. Similarly, the front panel 144 may include a window indicated by reference 145 in FIG. 3. The right side panel 142a is configured with a zipper or snap opening. As also shown in FIG. 3, the left side panel 142b may be configured to extend outwardly thereby increasing the interior space inside the camper trailer 100 in the open or tent mode 127.

Referring to FIG. 1, the camper trailer 100 may be configured with a solar panel 150 affixed or attached to the top of the upper housing section or shell 112. The solar panel 150 is configured to generate electrical energy which can be used to power an interior or dome light 152 mounted inside the tent enclosure and/or a compact flat screen TV or monitor 154. According to another aspect, the camper trailer 100 may be configured with an energy storage device, for instance a battery, which is operatively coupled to the solar panel 150 through a charging circuit and utilized to power the dome light 152 and/or flat screen TV 154 at night, as described in more detail below.

The trailer or base frame 120 comprises two wheels 122, indicated individually by references 122a and 122b. According to an exemplary embodiment, the wheel(s) 122 may be motorized to provide a power assist to move the camper trailer 100. According to an exemplary implementation, each of the wheels 122 is coupled to an electric motor 300 through a drive mechanism 310 (for instance, belt drive or direct drive). The camper trailer 100 includes a control and charging circuit 320 and a battery 330 for powering the electric motor 300. According to an exemplary embodiment, the charging circuit 320 is coupled to the solar panel 150 (as described above with reference to FIG. 1) and configured to charge the battery 330 utilizing the solar panel 150 as DC power source or input. According to another aspect, the electric motor 300 is configured with a remote controller for power on/off and speed control, which can be accessed by the rider on the bicycle. According to an exemplary implementation, the motor 300 and the drive mechanism 310 are contained in a weatherproof housing 340.

According to an embodiment, the control/charging circuit 320 is configured to charge the battery 330 utilizing an AC power source, for instance, the motor 300. According to an embodiment, the motor 300 comprises an electric motor/alternator which is configured to generate an AC output to the charging circuit 320 for charging the battery 330. According to an another embodiment, the motor 300 comprises a motor generator, for example, the MGU-K motor generator from Motor Generator Unit-Kinetic. The motor 300 may be implemented using a geared hub or a direct drive configuration. According to an exemplary implementation, the charging circuit 320 is operatively coupled to the front and/or rear hand brakes of the bicycle and configured to be responsive to a braking signal when the hand brake(s) is engaged, for example, utilizing wireless signal(s) between the handbrakes and the charging circuit 320. In response, the charging circuit 320 operates in a charging mode and utilizes the output from the motor 300 to charge the battery 330. The charging circuit 320 comprises a charge controller configured to regulate the charging current to the battery 330 based on the output from the motor 300 and/or the solar panel 150 to control the charging of the battery 330 and/or prevent overcharging of the battery 330. According to another aspect, the control/charging circuit 320 is configured to control the output from the battery 330 to power the interior light 152 and/or the flat screen TV and an electrical outlet 155 installed in the lower housing section 114 (FIG. 1), for charging mobile devices and the like.

According to another aspect, the control/charging circuit 320 is configured to engage the drive mechanism 310 for the motor 300, for example, the MGU-K motor generator, at a minimum preset speed or threshold and with further control to accommodate negative load, for example, under braking. The charging circuit 320 may also be configured to accommodate a maximum preset speed to threshold for redirecting/charging the battery 330 under control of the circuit 320. According to another aspect, the control/charging circuit 320 may be configured to engage the motor 300 “on-demand” and/or maintain the motor 300 in a neutral mode within minimum and maximum speed limits, for example, in response to control signal(s) or input(s) from the rider or cyclist. According to an exemplary implementation, the motor 300, for instance, the MGU-K motor from Motor Generator Unit-Kinetic, comprises a rated power output of 750 W. The particular implementation details for the motor and charging control circuit will be within the understanding of one skilled in the art.

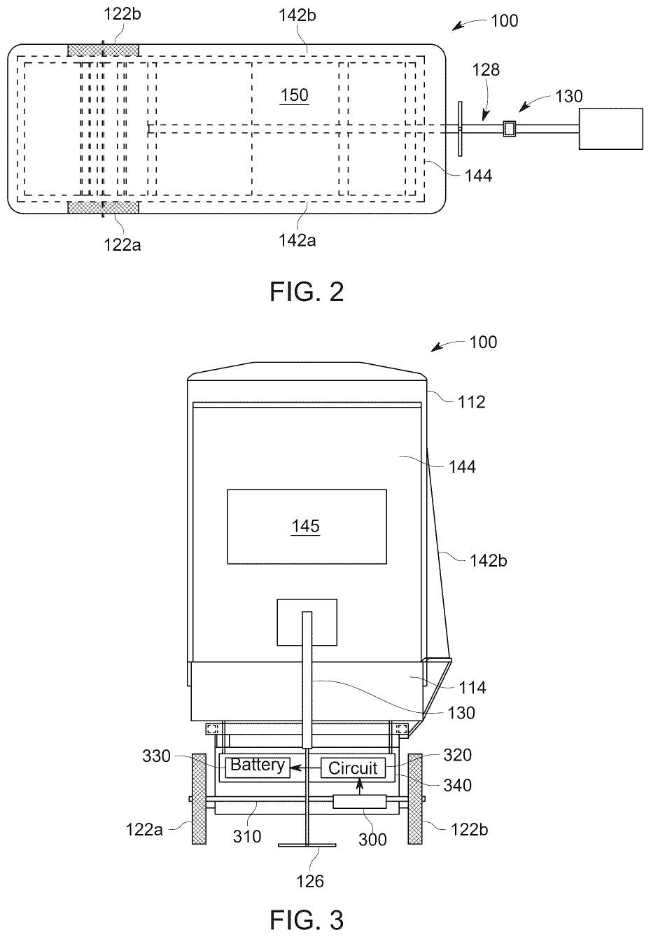

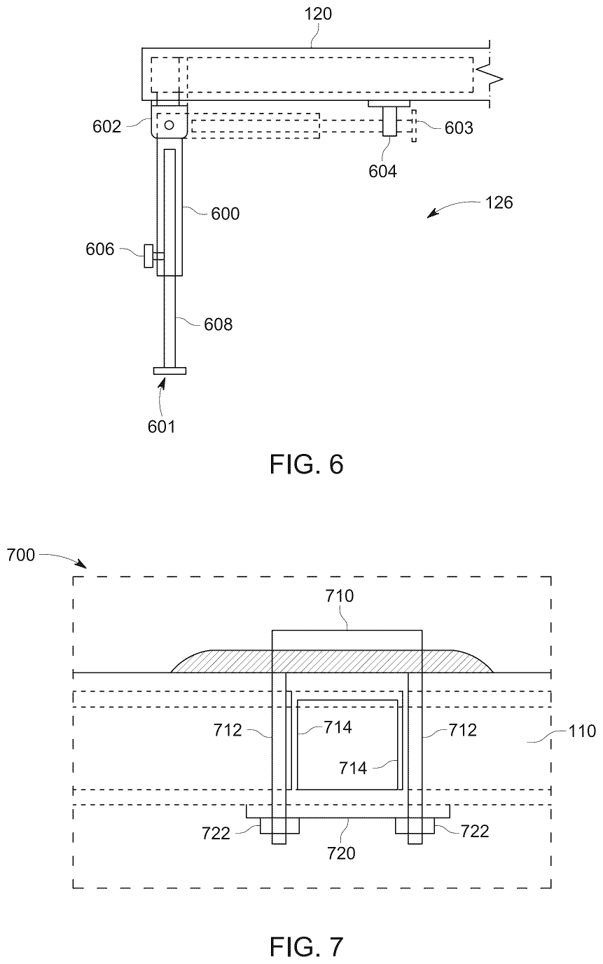

As shown in FIG. 1 and according to an exemplary embodiment, the trailer frame 120 includes a rear stand assembly 124 and a front stand assembly 126 as shown in FIG. 1. The rear stand assembly 124 is coupled to a rear section of the camper trailer frame 120 as shown in FIG. 1. The front stand assembly 126 is connected to a front section of the camper trailer 120 as shown in FIG. 1. The front and rear stand assemblies 126, 124 are configured to engage the ground and stabilize the camper trailer 100, i.e. prevent tipping. The rear stand assembly 124 may be implemented according to an embodiment as shown in FIG. 6. The rear stand assembly 124 comprises an extendible leg 600 which is connected to the trailer frame 120 through a pivotable or hinged connector 602. The extendible leg 600 is configured to swing between a lowered position 601 and a raised position 603. The rear stand assembly 124 includes a bracket or clamp 604 attached to the camper trailer frame 120 for securing the extendible leg 600 the raised position 603. According to an exemplary embodiment, the extendible leg 600 includes a releasable clamp 606 for raising/lowering a lower leg 608 to adjust the length of extendible leg to accommodate variations in the ground or surface underneath the camper trailer 100. The trailer frame 110 includes a trailer bar as shown in FIGS. 1 and 2, and indicated by reference 128. The front stand assembly 126 is coupled to a section of the trailer bar 128 as shown in FIG. 1. According to an exemplary implementation, the front stand assembly 126 comprises a ratcheting mechanism indicated by reference 129 to provide the capability to raise and lower the front stand assembly 126 as needed. As shown, the front stand assembly 126 includes a shoe or base member to stabilize and support the trailer frame 110 (and the trailer camper 100) in an upright position for camping or for storage.

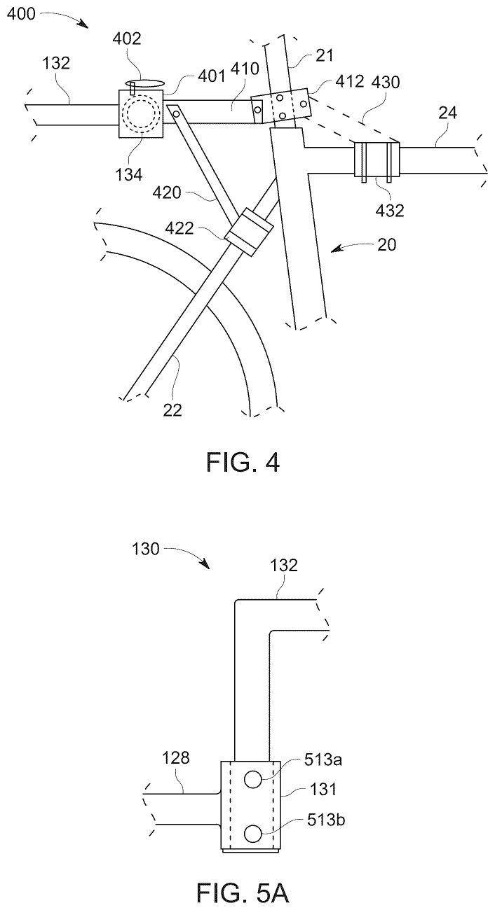

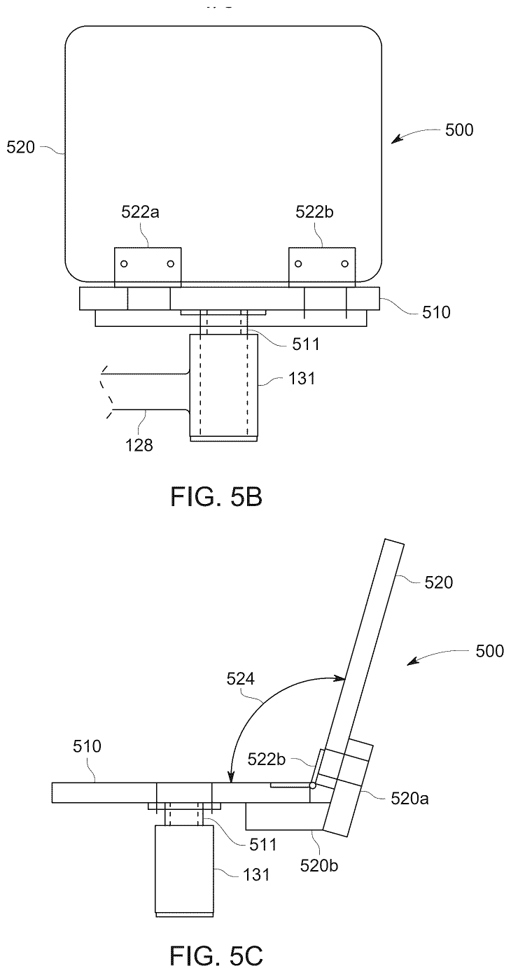

As shown in FIGS. 1, FIG. 4 and FIG. 5A, the trailer camper 100 includes a hitch bar assembly indicated generally by reference 130. The hitch bar assembly 130 is coupled to the trailer bar 128 and is configured to couple or hitch the trailer camper 100 to a bicycle 20. As shown in FIG. 5, the hitch bar assembly 130 comprises a hitch bar indicated by reference 132 which is coupled to the trailer bar 128 through a trailer hitch bar socket or bracket 131 secured, e.g. bolted, to one end of the trailer bar 128 and a corresponding end of the hitch bar 132. The other end of the hitch bar 132 is coupled to a hitching assembly 400 which is connected to the bicycle 20 as shown in FIG. 4. The hitching assembly 400 comprises a socket 401 which is configured to receive and engage hitch ball 134 on the end of the hitch bar 132. The socket 401 is configured with a clamp for securing the hitch ball 134 in the socket. The hitch bar assembly 130 includes a bicycle hitch bar indicated by reference 410, which is secured to the seat tube 21 of the bicycle 20 with a clamp or mounting bracket indicated generally by reference 412. As shown, the bicycle hitch bar 410 is further secured by a pair of support bars indicated generally by reference 420. Each of the support bars 420 is secured to a respective rear or seat stay 22 of the bicycle 20 with a clamp or bracket 422. As shown in FIG. 4, the hitch bar assembly 130 may include an additional support bar indicated by reference 430. The support bar 430 is secured to the bicycle 20 with a clamp 432 that is coupled or attached to the top tube 24 of the bicycle 20.

Reference is next made to FIGS. 5A-5C. According to aspect, the hitch bar assembly 130 is configured with a removable seat assembly indicated generally by reference 500. The seat assembly 500 comprises a seat base 510 and a seat back 520 and provides a seat for a rider to sit and rest. According to an exemplary embodiment, the seat 510 comprises a seat post 511 which is affixed or attached to the bottom of the seat as shown in FIGS. 5B and 5C. The seat post 511 is configured to fit inside or couple to the trailer hitch bar or bracket 131 when the hitch bar 132 shown in FIG. 5A is removed from the trailer hitch bracket as shown in FIGS. 5B and 5C. According to an exemplary implementation, the seat post 511 is secured in the trailer hitch bar bracket 131 with one or more bolts 513, indicated individually by references 513a and 513b, as shown in FIG. 5A. According to an exemplary implementation, the seat back 520 is coupled to the seat base 510 utilizing hinges 522, indicated individually by references 522a and 522b. This configuration allows the seat back 520 is swing or pivot between a closed position and an open position indicated by arrow 524. To maintain the seat back 520 in an upright position, the seat assembly 500 includes respective seat backs or stops 526, indicated individually by references 526a and 526b. The seat back 520 may be folded down with the seat assembly 500 mounted in the trailer hitch bracket 131 or for storage when the seat assembly 500 is removed or disconnected from the trailer hitch bracket 131.

The camper unit 110 is coupled to the trailer frame 120 utilizing clamping brackets 700, indicated individually by references 700a, 700b as shown in FIG. 1. According to an exemplary embodiment, the clamping brackets 700 each comprise a U-bolt 710 with two threaded ends 712 which are inserted through holes in the floor or base of the lower housing section or shell 114 and into corresponding through or bore holes 714 in the trailer frame 120. The clamping brackets 700 are secured to the trailer frame 120 with respective threaded nuts or other suitable fasteners 722. According to an exemplary implementation, a plate 720 is inserted between the threaded fasteners 722 and the trailer frame 110 to further reinforce the clamped connection between the camper housing 110 and the trailer frame 120.

Reference is next made to FIG. 8, which shows in diagrammatic form the camper trailer 100 attached to a roof carrier frame or rack 30, which is mounted on a vehicle 10. According to an exemplary implementation, the camper trailer frame 120 is configured to be attached or coupled to and supported by the roof rack 30. According to an embodiment, the camper trailer frame 120 is configured to be fixedly attached to the roof rack 30 utilizing U-shaped threaded rod brackets 32, indicated individually by references 32a and 32b. As shown the wheels 122 have been removed, for example, utilizing a quick-release mechanism. In this configuration, the camper trailer 100 functions as a roof-top carrier in addition to being convertible into a camper trailer 100 hitched to a bicycle 20, as described above with reference to FIG. 4 above. According to an embodiment, the camper trailer frame 120 is configured with easily releasable or quick release clamps which couple or attach the camper trailer frame 120 to the roof carrier frame 30. The camper trailer frame 120 may be configured to allow the wheels 122 to remain attached while the camper trailer 100 is mounted on the roof carrier frame 30. According to another embodiment, the camper trailer housing 110 is detached or uncoupled from the trailer frame 120, and the clamps 700a and 700b (FIG. 1) are configured or adjusted to attach or couple the camper trailer housing 110 to the roof carrier frame 30. According to this embodiment, the camper trailer housing 110 is configured as a stand-alone or convertible roof-top carrier separate from the camper trailer frame 120, for example, on an extended road trip where the housing 110 is not utilized as camper trailer 100 with a bicycle.

Reference is next made to FIG. 9 which shows a trailer camper configuration according to another embodiment and indicated generally by reference 200. The trailer camper 200 comprises a camper or housing unit indicated by reference 210 which is coupled or mounted on the trailer frame 110, in a manner similar to that described above. The camper or housing unit 200 comprises an upper housing section or shell 212 and a lower housing section or shell 214. The upper shell 212 and the lower shell 214 are connected a longitudinal side to provide a side opening orientation or configuration. According to an exemplary implementation one or more hinge assemblies indicated generally by reference 220 couple the upper 212 and the lower 214 housing sections together and allow the camper unit 110 to be opened and closed as indicated by arrow 222.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

### List of Reference Numerals

10—vehicle
12—vehicle cargo rack or carrier
20—bicycle
21—seat tube
22—rear stay
24—bicycle top tube
30—roof carrier frame or roof-rack
32—roof rack clamp
100—camper trailer
110—camper trailer housing
112—camper trailer upper housing section
113—housing section connection hinge or mechanism
114—camper trailer lower housing section
120—camper trailer frame
122—camper trailer wheels
124—rear trailer stand assembly
125—swing or pivot between open or tent mode and closed or trailer mode
126—front trailer stand assembly
127—open or tent mode
128—trailer frame bar
129—ratcheting assembly
130—hitch bar assembly
131—bracket
132—hitch bar
134—hitch ball
130—trailer connection assembly
142—tent side panels
143—window
144—tent front panel
145—front panel window
146—support rod assembly
147—support rod
148—sliding track for support rod
150—solar panel
152—interior or dome light
154—flat screen TV or monitor
200—camper trailer according to another embodiment
210—camper trailer housing
212—camper trailer upper housing section
214—camper trailer lower housing section
220—hinge assembly
222—opening and closing of camper unit
300—motor
310—drive mechanism
320—control/charging circuit
330—battery or energy storage device
340—weatherproof housing or enclosure
400—hitching assembly
401—socket
402—socket clamp
410—bicycle hitch bar
412—mounting bracket
420—support bars
422—clamp or bracket
430—support bar
432—clamp or bracket
500—seat assembly
510—seat base or platform
520—seat back
522—hinges
524—swing between open and closed positions
526—seat back stops
600—extendible leg for rear stand assembly
601—lowered position
602—pivoting connector
603—raised position
604—clamp or bracket
606—releasable clamp
608—lower leg
700—clamping brackets (for attaching to camper trailer frame 120 or roof carrier rack)
710—U-bolt
712—threaded ends of U-bolt
714—bore or through holes
722—fasteners

1. A camper trailer for a bicycle, said camper trailer comprising:
a base frame, said base frame comprising one or more wheels and a connection assembly for coupling said camper trailer to the bicycle for towing the camper trailer;
a housing unit, said housing unit being configured to attach to said base frame;
said housing unit comprising a lower section and an upper section, said lower section and said upper section being coupled together on a common side with a hinge connector, and said upper section being further configured to move between an open or camping position and a closed or storage position; and
said housing unit including one or more flexible panels configured to define an interior camper space when said housing unit is moved into said open position.

2. The camper trailer as claimed in claim 1, wherein said base frame includes one or more attachments for securing the camper trailer to a rack installed on a vehicle.

3. The camper trailer as claimed in claim 1, wherein said one or more wheels includes a motor configured to move the camper trailer under power in response to one or more control signals.

4. The camper trailer as claimed in claim 3, further including an energy storage device, and wherein said motor is configured to operate as a generator and with the rotation of said one or more wheels said generator generates an electrical output for charging said energy storage device.

5. The camper trailer as claimed in claim 1, further including a solar panel, said solar panel being configured to be attached to an exterior surface of said housing unit and generate an electrical output for powering one or more electrical devices.

6. The camper trailer as claimed in claim 3, further including one or more of an interior light mounted inside the housing unit and a flat screen television mounted inside the housing unit, said interior light and said flat screen television being operatively coupled to an output port on said solar panel.

7. The camper trailer as claimed in claim 6, further including an energy storage device and a power and charging circuit, said solar panel having an output coupled to a charging input on said power and charging circuit for charging said energy storage device, and said power and charging circuit having one or more outputs for powering said interior light or said flat screen television.

8. The camper trailer as claimed in claim 4, further including a controller configured to be responsive to a braking signal from the bicycle and further configured to generate a control signal to control charging of said energy storage device by said motor, and said motor operating in under negative load during braking.

9. The camper trailer as claimed in claim 8, wherein said controller is further configured to be responsive to one or more control signals generated by a remote control in response to one or more inputs from a rider.

10. A camper trailer for a bicycle, said camper trailer comprising:
a base frame, said base frame comprising one or more wheels and a connection assembly for coupling said camper trailer to the bicycle for towing the camper trailer;
a housing unit, said housing unit being configured to attach to said base frame;
said housing unit comprising a lower section and an upper section, said lower section and said upper section being coupled together on a common side with a hinge connector, and said upper section being further configured to move between an open or camping position and a closed or storage position; and
said housing unit including one or more flexible panels configured to define an interior camper space when said housing unit is moved into said open position; and
wherein said base frame includes one or more attachments for securing the camper trailer to a rack installed on a vehicle; and wherein said one or more wheels includes a motor configured to move the camper trailer under power in response to one or more control signals.

11. The camper trailer as claimed in claim 10, further including an energy storage device, and wherein said motor is configured to operate as a generator and with the rotation of said one or more wheels said generator generates an electrical output for charging said energy storage device.

12. The camper trailer as claimed in claim 10, wherein said housing unit includes one or more brackets configured to attach said housing unit to said base frame.

13. The camper trailer as claimed in claim 12, wherein said base frame includes one or more attachments for securing the camper trailer to a rack installed on a vehicle.

14. The camper trailer as claimed in claim 12, wherein said one or more brackets are configured to attach said housing unit to a rack installed on a vehicle.

15. The camper trailer as claimed in claim 10, wherein said housing unit is configured to be convertible into a roof rack carrier, said housing unit comprising a plurality of brackets for coupling said housing unit to a rack installed on a vehicle.
